(19) United States
(12) Patent Application Publication
(10) Pub. No.: US 2016/0193556 A1
(43) Pub. Date: Jul. 7, 2016

(54) FILTER FOR INDUSTRIAL DUST REMOVAL HAVING A SEALING STRIP

(71) Applicant: BWF TEC GMBH & CO. KG, Offingen (DE)

(72) Inventors: Thomas HILLIGARDT, Harthausen (DE); Georg FOCK, Bächingen (DE); Eduard SCHWAB, Günzburg (DE)

(21) Appl. No.: 14/916,410

(22) PCT Filed: Sep. 1, 2014
(86) PCT No.: PCT/EP2014/002357

§ 371 Date: Mar. 3, 2016

(30) Foreign Application Priority Data
Sep. 3, 2013 (DE) 10 2013 014 648.8

(51) Int. Cl. B01D 46/00; B29C 65/18; B29C 65/00; B01D 46/02

(52) U.S. Cl. CPC B01D 46/0001; B01D 46/02; B29C 65/18; B29C 66/5326; B29K 2627/18

(57) ABSTRACT

The present invention relates to a filter for industrial dust removal, a method of manufacturing the same, and a calendar device for manufacturing the same. The filter for industrial dust removal may include a filter body formed of a flat filter medium and a sealing band. The filter body may include a seam region with passage channels through which at least one sewing thread is guided, and the sealing band may be arranged on the seam region and connected with the flat filter medium, such that a passage of particles through the passage channels is prevented. In the filter for industrial dust removal, the sealing band may preferably be made of polytetrafluoroethylene. In a particularly preferred manner the sealing band is formed as a dense foil or as a microporous structure of pure expanded polytetrafluoroethylene. Preferably, the sealing band may also cover a joint of the flat filter medium.

The present invention relates to a filter for industrial dust removal, a method of manufacturing a filter for industrial dust removal, and a calender device for manufacturing such a filter.

Filters for industrial dust removal serve to eliminate finely distributed, solid foreign substances from a gas. They are used in plants of the most various industrial fields, for instance, asphalt mixing plants, biomass heating plants, plants of chemical and pharmaceutical industry, in food industry, or in thermal waste treatment. In all of these industrial fields high concentration of dust particles frequently occurs. Industrial dusts are very variegated and have usually a particle size between 0.1 and 1,000 μm. Dust filters are responsible for cleaning the gas flow from dust particles. These filters are used in different forms in industrial dust removal. Frequently, so-called filter tubes are used, i.e. filters having a tubular filter body. In the dust removal installation the filter tubes are fitted on supporting cages which stabilize the filter tubes and keep them in shape. In the dust removal installation the filter separates the crude gas side from the clean gas side, i.e. gas with a high concentration of dust particles is present at one side of the filter while the concentration of dust particles at the other side of the filter is substantially lower. In the ideal case the concentration of dust particles at the other side of the filter should be negligible or al-most negligible. For dust removal, the gas thus flows from the crude gas side through the filter to the clean gas side. In this process, preferably the majority of the dust particles are to be eliminated at the filter.

Filters for industrial dust removal have therefore generally a very fine-pored filter medium. The required size of the pores depends on the field of use of the filter. The finer the dusts to be caught by the filter are, the smaller the pores must be. For achieving a particular filter performance it is therefore mandatorily required that the filter does not comprise any accidental leakages.

Filters for industrial dust removal may be made of different materials. They usually comprise a textile material. Such a textile material may be a tissue of the most different fibers, for instance, glass fibers, polytetrafluoroethylene (PTFE) fibers or other polymer fibers. These tissues are frequently faced with polymer staple fibers which are needled such that a felt is produced. These polymer staple fibers may also consist of different materials, in particular of PTFE. A typical filter for industrial dust removal therefore comprises a support tissue bearing a layer of needled polymer staple fibers on one or both sides thereof. The filter may additionally comprise a membrane which is, for instance, laminated on the needle felt. The membrane may in particular be a PTFE membrane. Another example of a typical filter for industrial dust removal is a glass fabric which is preferably—possibly partially—provided with a finishing of PTFE and which has a PTFE membrane laminated thereon.

A flat filter medium which is usually available in the form of web material frequently serves as a starting material for a filter. A filter for industrial dust removal is produced from this web material by means of making up. For this purpose, pieces of the required shape and size are cut from the web material, which are then assembled in the desired shape. A filter tube, for instance, which has a cylindrical shape is typically assembled of at least two filter pieces. The filter sleeve is formed of a rectangular filter piece, two opposing sides of which are joined at a joint. A circular filter piece serves for closing the cylinder bottom. For this purpose it is connected with the first filter piece.

The circular shape is not mandatory for the bottom, flat tubes or tubes which are simply sewed at the bottom do also exist. Conical tube shapes having a cut which rather corresponds to a trapezoid shape are also possible.

Depending on the material of the web material different methods may be used for joining, during the making up, the pieces of the filter obtained from the web material, for instance, to a filter tube. If the web material has a high proportion of thermoplastic polymers such as polyester (PES) or polyphenylene sulfide (PPS), at least the longitudinal seam of the filter tube may be welded in particular by means of hot air, a hot wedge, or ultrasound, and hence be designed to be impermeable for particles. In the case of materials which cannot be joined thermoplastically such as PTFE felts or glass fabric, this is not possible, so that a sewing process is regularly resorted to.

A typical filter tube for industrial dust removal therefore comprises a plurality of seams. Each of these seams in turn comprises a plurality of needle punctures through which a sewing thread is guided. This involves the risk that passage channels for particles, in particular for fine particles, are formed by the needle punctures since the sewing thread only partially fills the interior of the sewing hole and covers it in cross-section. The use of even thinner needles is restricted by the sewing thread and its thickness which is necessary for reasons of strength. The needle punctures thus may possibly result with high probability in that the filter detectably comprises leakages which are hard to control.

The needle and the puncture hole thus have, caused by the system, basically a larger diameter than the sewing thread.

It is therefore an object of the present invention to improve such a filter for industrial dust removal such that the risk of a particle passage through the sewing channels is eliminated.

This object is solved by the filter for industrial dust removal in accordance with the invention with the features according to claim 1. Advantageous further developments of the filter in accordance with the invention are indicated in subclaims 2 to 7. Claim 8 indicates a method of manufacturing a filter for industrial dust removal in accordance with the invention. Furthermore, claim 12 relates to a calender device for manufacturing a filter for industrial dust removal in accordance with the invention.

The filter for industrial dust removal in accordance with the invention comprises a filter body formed of a flat filter medium and a sealing band, wherein the filter body comprises a seam region with passage channels through which at least one sewing thread, i.e. one or a plurality of sewing threads, is/are guided, and wherein the sealing band is arranged on the seam region and connected with the flat filter medium such that a passage of particles through the passage channels is prevented. The sealing band is preferably made of polytetrafluoroethylene (PTFE). Advantageously, the sealing band is formed of pure expanded polytetrafluoroethylene (ePTFE), preferably as a dense film or as a microporous structure. The sealing band is preferably a membrave film, in particular a stretched, fibrillated ePTFE membrane as it is also used for laminates.

In accordance with an alternative embodiment of the invention the sealing band consists of a LD-PTFE film which is not stretched and/or expanded and not stabilized, either.

The use of pure PTFE material for the sealing band yields the advantage that a chemically and thermally very stable material is used which does not cause any limitation for the conditions of use of the filter. Thus, the sealing band of the filter according to the invention differs from conventional seam sealing bands which are generally of multi-layer structure and comprise a meltable layer with a comparatively low melting point (for instance 130° C.). By means of this meltable layer the conventional seam sealing bands may be fused on a filter and connected firmly therewith. This connection is, however, stable up to the melting point of the meltable layer only, so that the corresponding filters can only be operated below this melting point. Such filters cannot be used at higher temperatures. The melting layer is frequently also chemically susceptible, so that the field of use of such filters is further restricted to environments which are little aggressive in chemical respect.

The sealing band of the filter in accordance with the invention preferably has a thickness in the range of 5 μm to 200 μm, particularly preferred in the range of 50 μm to 100 μm. The sealing band is advantageously designed and arranged to reach beyond the seam region to be sealed by 3 mm to 5 mm at both sides. The sealing band has preferably a breadth in the range of 20 mm to 30 mm.

The flat filter medium preferably comprises a finishing. Such a finishing enables to increase the adhesion of the sealing band on the filter medium. In particular if the filter medium consists of non-meltable or at least not sufficiently softening polymers or, for instance, glass materials, it is of advantage if the filter medium is provided with a finishing which then serves quasi as a glue for the sealing band. A PTFE or fluoropolymer-based finishing is used in a particularly preferred manner.

In the filter for industrial dust removal according to the invention, adhesion of the sealing band on the seam region is achievable preferably by pressing the sealing band on the flat filter medium under pressure and, depending on the material and the operating speed, at increased temperatures. The roll pressure is e.g. up to approx. 7 bar, wherein the pressure on the material is, for instance, determined by a gap orientating itself at the thickness of the material supplied; it is e.g. in the range of approx. 1 N/mm² to approx. 100 N/mm². The increased temperatures may, for instance, be in the range of approx. 350° C. to approx. 600° C. During the pressing of the sealing band on the flat filter medium the sealing band and the filter medium are heated in the region to be sealed advantageously to a temperature in which both the sealing band and material shares of the flat filter medium, such as the finishing thereof, start melting or are at least slightly softened. Thus, it is possible to achieve a safe adhesion of the sealing band on the flat filter medium even with a sealing band which consists of pure PTFE.

Preferably, the filter body of the filter for industrial dust removal according to the invention comprises a joint at which at least two layers of the flat filter medium are joined, wherein the sealing band is arranged and applied on the joint such that it covers the joint in a manner impermeable for particles.

The method of manufacturing a filter for industrial dust removal according to the invention comprises the following steps: forming a filter body of a flat filter medium; sewing at least two layers of the flat filter medium in a seam region; arranging a sealing band on the seam region; pressing the sealing band on the flat filter medium under pressure and at increased temperature such that the sealing band adheres on the seam region. Preferably the sealing band is arranged such that it covers, in addition to the seam region, also a joint at which two layers of the flat filter medium are joined in a superimposed manner. In accordance with the invention the sealing band then covers both the seam region and the joint.

In the method according to the invention the sealing band is preferably made of polytetrafluoroethylene. Advantageously, the step of pressing the sealing band on the flat filter medium is performed by means of a calender device. The calender device preferably comprises a stepped roll geometry.

The calender device for manufacturing a filter for industrial dust removal according to the invention comprises an outer roll and an inner roll designed as a support roll, wherein the outer roll comprises a stepped roll geometry and is designed to be heated evenly.

Both rolls may be of stepped or smooth structure and have a shape corresponding to the shape of the seam. Both rolls may also be designed to be heated so as to also apply a sealing band at the rear side of the filter, for instance.

In the seam region the filter body generally has a larger thickness than outside of the seam region since at least two layers of the flat filter medium are superimposed in the seam region. If the stepped roll geometry of the outer roll is adapted to the shape and size of the seam region it is possible to apply even pressure on the filter body in the seam region and outside of the seam region by the outer roll. Thus, it is possible to press the sealing band on the filter medium with even pressure over a wide region. If the sealing band is pressed on the filter medium by the outer roll and the outer roll is designed to be heated evenly, the temperature of the sealing band may moreover be increased during pressing. Thus, better adhesion of the sealing band may be achieved. The outer roll is preferably adapted to be heated evenly to a temperature of at least 200° C., and particularly preferred to a temperature of up to 600° C.

In accordance with an additional or alternative aspect of the present invention, the inner and the outer rolls can only be used partially since then the support roll may also be arranged below the tube body and not mandatorily within the tube body. Moreover, it is also possible to use a second heated roll which synchronously applies a second band on the underside and makes it adhere.

The calender device according to the invention is preferably designed such that it can be used alone or can be mounted downstream to the sewing arm of a sewing machine, so that the producing of a seam on a filter may be performed synchronously with the feeding and pressing of a sealing band preferably with the usual sewing speeds of 6 m/min to 15 m/min.

In the calender device for manufacturing a filter for industrial dust removal in accordance with the invention the inner roll preferably has a hardness equal to or smaller than the hardness of the outer roll. Thus, it is in particular possible to compensate for possible irregularities in the thickness of the filter medium by a deformation of the inner roll. The inner roll preferably has a hardness of approx. 70 Shore A auf.

It is also conceivable that the inner roll is designed with less hardness and/or with several layers, e.g. with 40 Shore or combined with 40 Shore outside and 70 Shore inside.

The outer roll is preferably formed of steel and the inner roll preferably of silicone. Advantageously the inner roll also comprises a stepped roll geometry. Then it is possible to favorably adapt the shape of the outer roll and that of the inner roll to the shape of the seam region in particular in the case of particularly thick seam regions.

The calender device according to the invention is preferably designed such that it can be opened at one side. This has the advantage that then the region of the filter which is to be sealed with the sealing band may be introduced laterally in the calender device. Thus, it is possible to also seal seams in the collar region of a filter tube, in particular also seams arranged in parallel to the outer edge of the filter tube, with a sealing band.

In the following, preferred embodiments of the present invention will be explained in more detail by means of Figures.

There show:

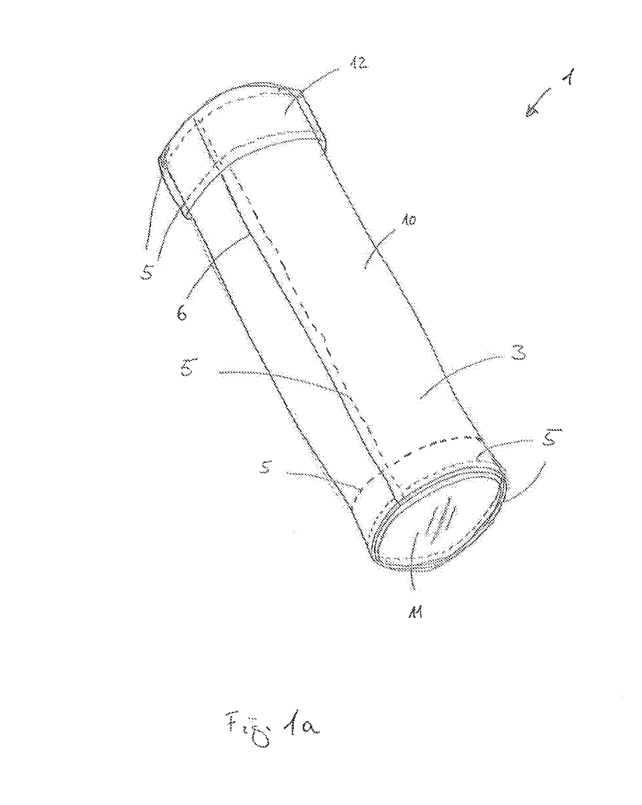

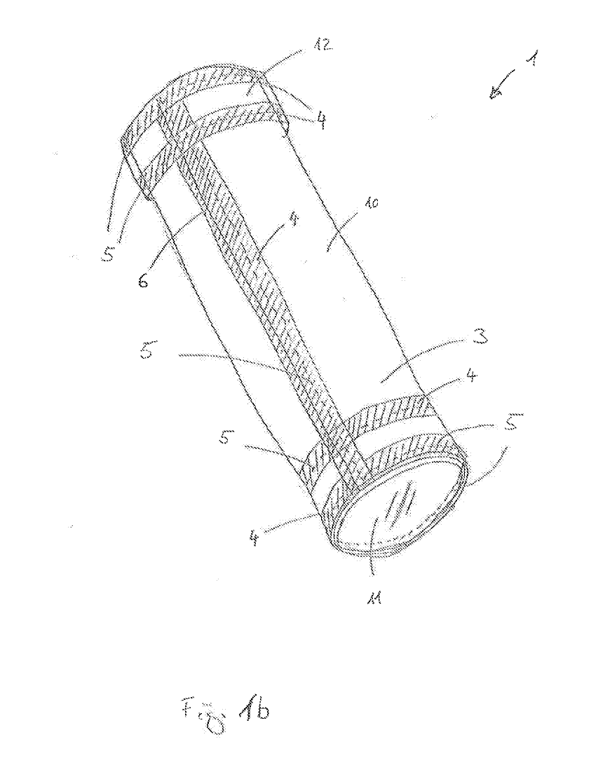

FIG. 1a a perspective illustration of a conventional filter tube with a filter body formed of a flat filter medium;

FIG. 1b a perspective illustration of a filter in accordance with the invention in the form of a filter tube with seam regions sealed by means of sealing bands;

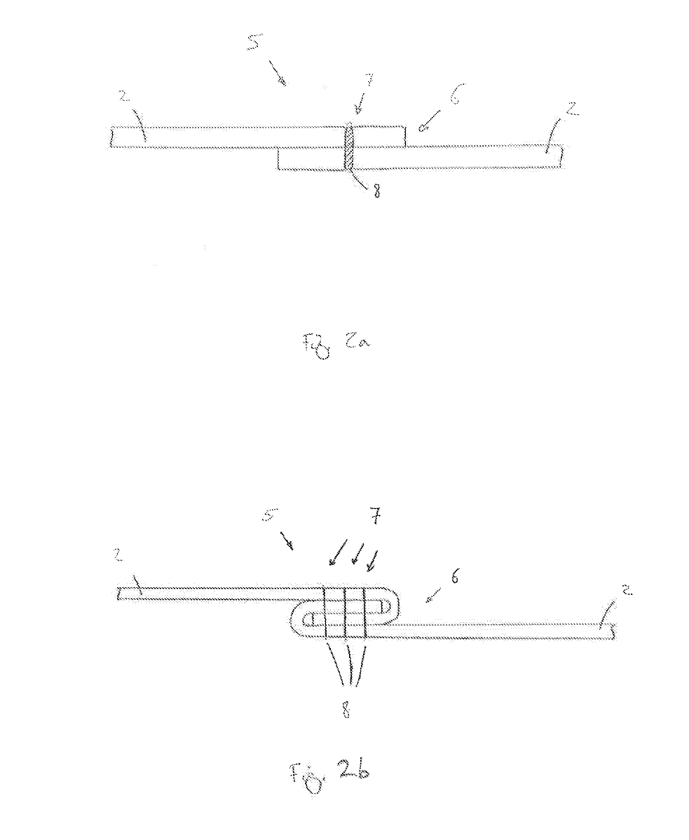

FIG. 2a a section from a filter body of a conventional filter in which two layers of a flat filter medium are connected with each other by a plain seam;

FIG. 2b a section from a filter body of a conventional filter in which two layers of a flat filter medium are connected with each other by a lapped-fell seam;

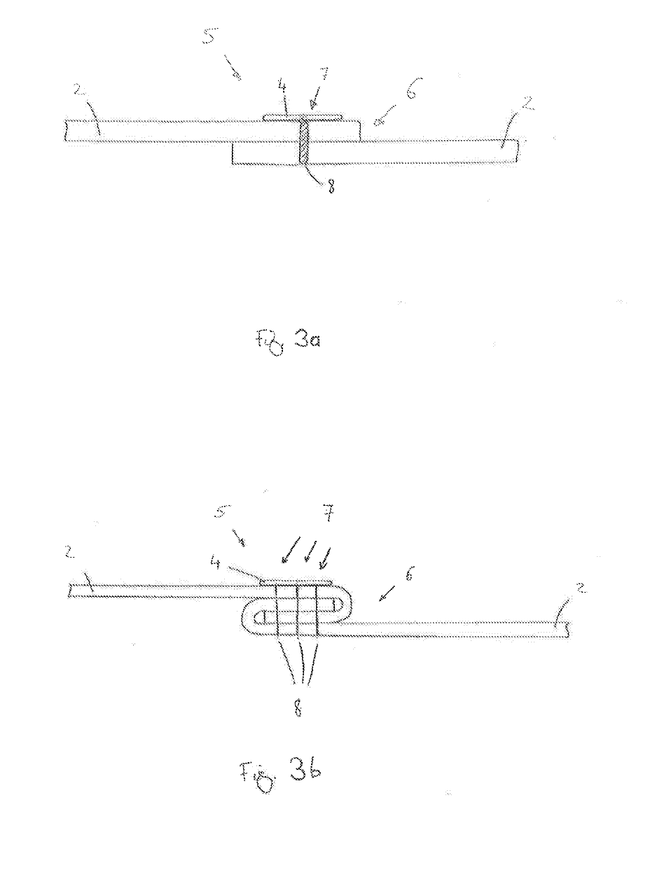

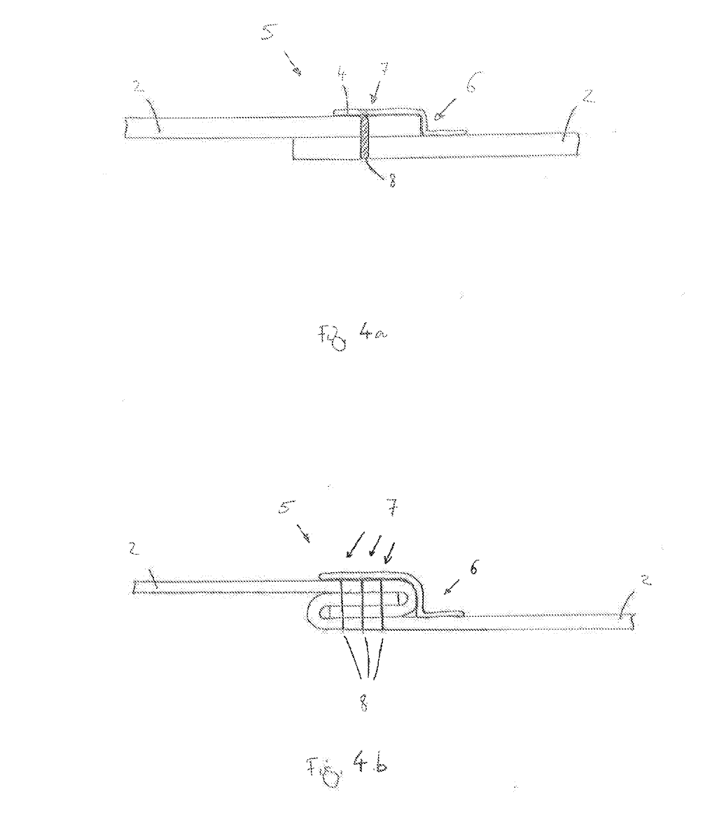

FIG. 3a a section from a filter in accordance with the invention in which a sealing band covers a seam region;

FIG. 3b a section from a filter in accordance with the invention in which a sealing band covers a lapped-fell seam;

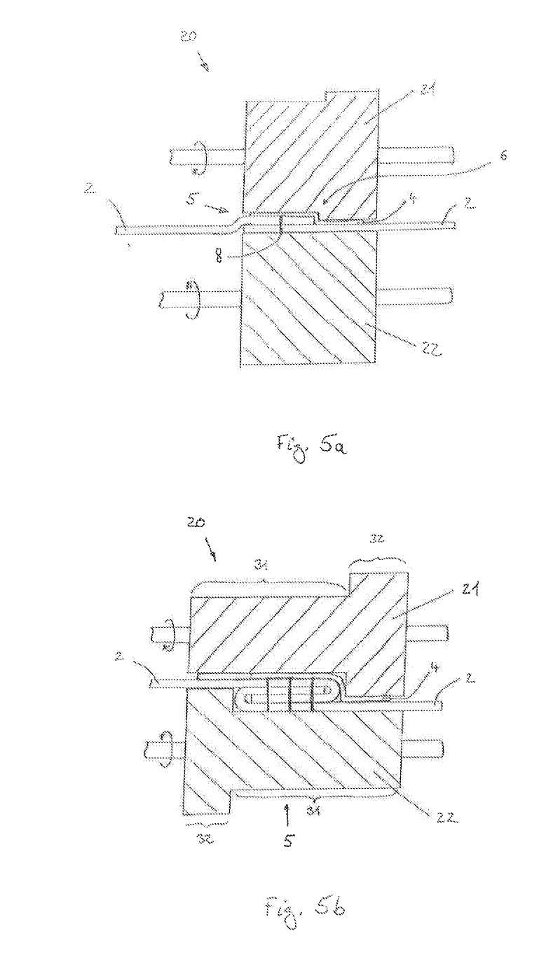

FIG. 4a a section from a filter in accordance with the invention in which a sealing band covers a seam region and a joint;

FIG. 4b a section from a filter in accordance with the invention in which a sealing band covers a lapped-fell seam and a joint;

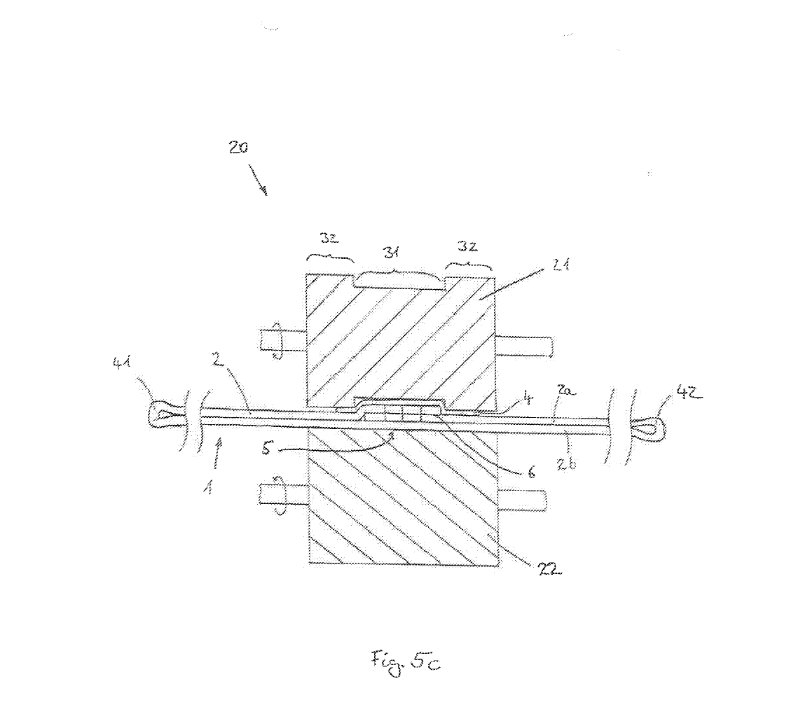

FIG. 5a a sectional view through the outer roll and the inner roll of a calender device in accordance with the invention;

FIG. 5b a sectional view through the outer roll and the inner roll of a calender device in accordance with the invention, wherein both the outer roll and the inner roll comprise stepped roll geometries;

FIG. 5c a sectional view through the first roll and the second roll of a calender device in accordance with the invention, wherein the first roll comprises a groove and a filter is guided in a double-layer arrangement between the rolls.

FIG. 1a illustrates a conventional filter 1 for industrial dust removal in the form of a filter tube. This filter tube comprises a filter body 3 formed of a flat filter medium. This filter body 3 is of cylindrical design and comprises a cylinder sleeve and/or a wall 10, a bottom 11, and a collar region 12. The wall 10 is formed of a rectangular piece of a flat filter medium, two opposite edges of which are superimposed in an overlapping region and are connected with each other in a seam region 5 by a seam. The bottom 11 is here, for instance, of circular design and is connected with the wall 10 also by a seam in a seam region 5; the circular shape is, however, not mandatory. At the end of the cylinder opposite to the bottom 11 the filter body 3 is open and comprises a collar region 12 in this region which is formed by an additional layer of the flat filter medium which is also connected with the wall 10 by seams in a seam region 5. The needle punctures in the seam regions 5 may result in accidental leakages of the filter 1.

FIG. 1b illustrates a filter 1 in accordance with the invention which differs from the filter illustrated in FIG. 1a in that it comprises sealing bands 4 which are arranged on the seam regions 5 and connected with the flat filter medium such that a passage of particles through the passage channels formed by the needle punctures is prevented.

FIG. 2a illustrates a section from a conventional filter with a seam region 5. Two layers of a flat filter medium 2 are superimposed in the seam region 5 such that a joint 6 results. A plain seam is illustrated in FIG. 2a. In practice, however, three-fold seams are commonly used, in particular in the case of filter tubes which are cleaned by means of the pulse jet method. The seam region 5 comprises, in particular in the case of a three-fold seam, a plurality of passage channels 7 through which a sewing thread 8 is guided. In the case of such a filter the danger exists that particles get through the passage channel 7 from the one side of the filter to the other side, in particular from the crude gas side to the clean gas side. The seam thus produces leakage in the filter which is impossible or only hard to control.

FIG. 2b illustrates a section from a conventional filter in which two layers of a flat filter medium 2 are connected with each other by a lapped-fell seam, as is usually the case with filters with glass fabric. In the seam region 5 the filter comprises the four-fold strength of the flat filter medium 2. The thickness of the filter body in the seam region 5 thus differs strongly from the thickness of the filter body outside of the seam region 5. The two layers of the flat filter medium 2 are connected with each other by a three-fold seam in the lapped-fell seam. Thus, also in the case of the lapped-fell seam passage channels 7 are produced through which the particles may get from the crude gas side to the clean gas side.

FIG. 3a illustrates a section from a filter in accordance with the invention according to a preferred embodiment. This filter in accordance with the invention differs from the filter illustrated in FIG. 2a in that the seam region 5 is covered by a sealing band 4. This sealing band 4 is arranged on the seam region 5 and connected with the flat filter medium 2 such that a passage of particles through the passage channels 7 is prevented. In the embodiment of the filter in accordance with the invention illustrated in FIG. 3a the filter body has, in the entire region covered by the sealing band 4, a constant thickness, namely the double thickness of the plain flat filter medium 2. Thus, it is particularly easy to press the sealing band 4 on the filter body under high pressure.

FIG. 3b illustrates a further preferred embodiment of the filter in accordance with the invention which differs from the filter illustrated in FIG. 2b in that a sealing band 4 is arranged on the seam region 5 and connected with the flat filter medium 2 such that a passage of particles through the passage channels 7 is prevented. Here, too, the filter body has, in the entire region covered by the sealing band 4, a constant thickness. Since the two layers of the flat filter medium 2 are connected with each other in a lapped-fell seam, this region has the four-fold strength of the plain flat filter medium 2. In the case of such a large thickness difference of the filter body in the seam region 5 and outside of the seam region 5 it is particularly advantageous if the sealing band 4 is only arranged on the seam region 5 since it is not trivial to press the sealing band 4 with evenly high pressure on a filter body whose thickness varies strongly.

FIG. 4a illustrates a section from a filter in accordance with the invention according to a further preferred embodiment. In this filter two layers of a flat filter medium 2 are again connected with each other by a plain seam in a seam region 5. The filter has a joint 6 in the overlapping region of the two layers of the flat filter medium 2. A plurality of passage channels 7 through which a sewing thread 8 is guided is arranged in the seam region 5. Moreover, the filter in accordance with the invention comprises a sealing band 4 which covers both the seam region 5 and the joint. The sealing band 4. was pressed on the flat filter medium 2 under pressure and at increased temperature until it adhered thereto. By the fact that, in addition to the seam region 5, the joint 6 is also covered by the sealing band 4, it is not only prevented that particles get, through the passage channels 7 past the sewing thread 8, from the crude gas side to the clean gas side, but also that particles get through the joint 6 from the crude gas side to the clean gas side. Without such an arrangement of the sealing band 4 there is in particular the risk that particles get through the joint between the two layers of the flat filter medium 2 and from there into the passage channel 7. The arrangement of the sealing band 4 illustrated in FIG. 4a thus has the advantage over the one illustrated in FIG. 3a that the joint 6 is additionally sealed. However, the applying of the sealing band 4 on the filter body is aggravated since now the thickness of the filter body varies in the region in which the sealing band 4 is applied. The variation of thickness in the region of the sealing band 4 is, however, not very distinct since the two layers of the flat filter medium 2 are connected with each other merely by a plain seam.

FIG. 1b illustrates a section from a filter in accordance with the invention according to a further embodiment. In this embodiment two layers of the flat filter medium 2 are connected with each other by a lapped-fell seam in the seam region 5. In the case of the lapped-fell seam a joint 6 also results at which the two layers of the flat filter medium are joined. In this embodiment the filter comprises a sealing band 4 which covers both the seam region 5 and the joint 6. Here, the filter body has a large thickness variation in the region in which the sealing band 4 is arranged. In the seam region 5 of the lapped-fell seam the filter body is four times as thick as outside of the seam region 5. Pressing the sealing band 4 on the filter body with a high, even pressure is therefore a particular challenge.

FIG. 5a illustrates a section from a calender device 20 in accordance with the invention in a sectional view. The calender device 20 serves to press a sealing band 4 on a filter comprising a flat filter medium 2. In FIG. 5a two layers of the flat filter medium 2 are superimposed in an overlapping region such that a joint 6 results. The two layers of the flat filter medium 2 are connected with each other by a plain seam with a sewing thread 8 in a seam region 5. With the calender device illustrated in FIG. 5a it is possible to press the sealing band 4 with even pressure in the seam region 5 and in the laterally adjacent region onto the flat filter medium 2 such that the joint 6 is also sealed by the sealing band 4 in addition to the seam region 5. The calender device 20 comprises an outer roll 21 and an inner roll 22. The inner roll 22 is designed as a support roll. The flat filter medium 2 is guided thereon. The outer roll 21 comprises a stepped roll geometry. The outer roll 21 thus does not have a constant diameter, but the diameter of the outer roll 21 changes step-like along the longitudinal axis thereof. Thus it becomes possible to press the sealing band 4 on the filter under constant pressure both in the seam region 5 in which the thickness of the filter corresponds substantially to the double thickness of the flat filter medium 2 and in the laterally adjacent region in which the thickness of the filter corresponds to the plain thickness of the flat filter medium 2. The outer roll 21 is designed to be evenly heatable, so that the pressing of the sealing band 4 on the filter may be performed at increased temperature. Thus, it is possible to improve the adhesion of the sealing band 4 on the filter.

FIG. 5b illustrates a section from a calender device 20 in accordance with the invention according to a further preferred embodiment. In this calender device 20 both the outer roll 21 and the inner roll 22 have stepped roll geometries. Each of the two rolls has a first region 31 with a first diameter and a second region 32 with a second diameter, wherein the second diameter is larger than the first diameter. The two rolls are arranged to be orientated oppositely to each other. In the outer roll 21 the second region 32 is positioned, for instance, as illustrated in FIG. 5b, at the right of the first region 31 whereas in the inner roll 22 the second region 32 is positioned at the left of the first region 31. Such an orientation of the two rolls enables their arrangement such that three zones can be differentiated in the region between the two rolls: First of all a first zone in which the first region 31 of the outer roll 21 is opposite to the second region 32 of the inner roll 22 (left zone in FIG. 5b). Subsequently a second zone in which the first region 31 of the outer roll 21 is opposite to the first region 31 of the inner roll 22 (middle zone in FIG. 5b). Finally a third zone in which the second region 32 of the outer roll 21 is opposite to the first region 31 of the inner roll 22 (right zone in FIG. 5b). In the first and third zones the two rolls have a smaller distance from each other than in the second zone. It is particularly advantageous if the dimension of the second zone is adapted to the dimension of the seam to be sealed, as illustrated in FIG. 5b, so that the seam region may be arranged in the second zone and fills it in substantially. This is because then the sealing band 4 may be pressed on the flat filter medium 2 by means of the calender device 20 in accordance with the invention under even pressure both in the seam region 5 and in the regions adjacent to the seam region 5, even if the thickness of the filter in the seam region 5 differs strongly from the thickness of the filter outside of the seam region.

FIG. 5c illustrates a section from a calender device 20 in accordance with the invention according to a further preferred embodiment. The calender device 20 comprises a first roll 21 and a second roll 22. The first roll 21 comprises a groove. In a centrally arranged first region 31 the first roll 21 thus has a smaller radius than in the two second regions 32 laterally adjoining the first region 31. The second roll 22 is designed as a support roll with a constant radius. In the arrangement illustrated in FIG. 5c the filter tube 1 formed of the flat filter medium 2 is guided in two layers between the two rolls 21 and 22 of the calender device 20. The filter tube 1 is flatly collapsed such that a first layer 2a of the flat filter medium 2 rests on a second layer 2b of the flat filter medium 2. The two layers 2a and 2b are connected with each other via a first folding zone 41 and a second folding zone +2. The double-stepped geometry of the first roll 21 is adapted to the dimensions of the seam region 5 such that the sealing band 4 may be pressed firmly on the first layer 2a of the flat filter medium 2 in the seam region 5 and beyond the joint 6. The first roll 21 is preferably designed as a heatable steel roll, the second roll 22 preferably as a silicone roll.

The calender device 20 illustrated in FIG. 5c is adapted to the processing of a flat seam. For sealing a lapped-fell seam the geometry of the first roll 21 has to be adapted in that the steps between the first region 31 and the second region 32 are enlarged. The arrangement of calender device 20 and filter tube 1 illustrated in FIG. 5c may, in accordance with the invention, also be used to press, in addition to the first sealing band 4 sealing the seam region 5 and the joint 6, a second sealing band (not illustrated) on the filter tube 1. This second sealing band is preferably pressed at the underside of the second layer 2b of the flat filter medium 2 opposite from the first sealing band 4 on the flat filter medium 2. Then, after sewing and sealing the filter tube 1 is preferably collapsed such that the folding zones which cannot be avoided during collapsing are formed in the regions in which the sealing bands are arranged. The flat filter medium 2 is then additionally protected by the sealing bands in the folding zones. In this variant of the calender device 20 according to the invention the second roll 22 is preferably also designed as a heatable steel roll.

In the calender device 20 illustrated in FIG. 5c it is not mandatory that the filter tube 1 is guided in two layers between the rolls. In accordance with the invention it is also possible, similar as illustrated in FIGS. 5a and 5b, to only guide one layer of the flat filter medium 2 through the calender device 20 in accordance with FIG. 5c. Likewise it is possible in the calender device 20 in accordance with FIG. 5a that the filter tube 1 is guided in two layers through the calender device 20.

### LIST OF REFERENCE SIGNS

1 filter
2 flat filter medium
2a first layer of the flat filter medium
2b second layer of the flat filter medium
3 filter body
4 sealing band
5 seam region
6 joint
7 passage channel
8 sewing thread
10 wall of the filter tube
11 bottom of the filter tube
12 collar region of the filter tube
20 calender device
21 outer/first roll
22 inner/second roll
31 first region
32 second region
41 first folding zone
42 second folding zone

1. A filter for industrial dust removal, comprising
a filter body formed of a flat filter medium; and
a sealing band, wherein the filter body comprises a seam region with passage channels through which at least one sewing thread is guided, and the sealing band is arranged on the seam region and connected with the flat filter medium such that a passage of particles through the passage channels is prevented.

2. The filter for industrial dust removal according to claim 1, wherein the sealing band is made of polytetrafluoroethylene.

3. The filter for industrial dust removal according to claim 2, wherein the sealing band is formed as a dense film or as a microporous structure of pure expanded polytetrafluoroethylene.

4. The filter for industrial dust removal according to claim 1, wherein the flat filter medium comprises a finishing.

5. The filter for industrial dust removal according to claim 4, wherein the finishing is polytetrafluoroethylene or fluoropolymer-based.

6. The filter for industrial dust removal according to claim 1, wherein adhesion of the sealing band on the seam region is configured to be formed by pressing the sealing band on the flat filter medium under pressure and at increased temperature.

7. The filter for industrial dust removal according to claim 1, wherein the filter body comprises a joint at which at least two layers of the flat filter medium are joined together, and the sealing band is arranged and applied on the joint such that it covers the joint to be impermeable for particles.

8. A method of manufacturing a filter for industrial dust removal, comprising the steps of:
forming a filter body of a flat filter medium;
sewing at least two layers of the flat filter medium in a seam region;
arranging a sealing band on the seam region;
pressing the sealing band on the flat filter medium under pressure and at increased temperature such that the sealing band adheres to the seam region.

9. The method of manufacturing a filter for industrial dust removal according to claim 8, wherein the sealing band is made of polytetrafluoroethylene.

10. The method of manufacturing a filter for industrial dust removal according to claim 8, wherein the step of pressing of sealing band on the flat filter medium is performed by means of a calender device.

11. The method of manufacturing a filter for industrial dust removal according to claim 10, wherein the calender device comprises a stepped roll geometry.

12. A calender device for manufacturing a filter for industrial dust removal, comprising an outer roll and an inner roll designed as a support roll, wherein the outer roll comprises a stepped roll geometry and is designed to be heated evenly.

13. The calender device for manufacturing a filter for industrial dust removal according to claim 12, wherein the inner roll has a hardness equal to or less than the hardness of the outer roll.

14. The calender device for manufacturing a filter for industrial dust removal according to claim 13, wherein the outer roll is formed of steel and the inner roll is formed of silicone.

15. The calender device for manufacturing a filter for industrial dust removal according to claim 12, wherein the inner roll comprises a stepped roll geometry.
